(19) United States
(12) Patent Application Publication
(10) Pub. No.: US 2021/0159541 A1
(43) Pub. Date: May 27, 2021

(54) ELECTROLYTE FOR LITHIUM BATTERY AND LITHIUM BATTERY COMPRISING SAME

(71) Applicant: SAMSUNG SDI CO., LTD., Yongin-si, Gyeonggi-do (KR)

(72) Inventors: Myunghwan JEONG, Yongin-si, Gyeonggi-do (KR); Kyoungsoo KIM, Yongin-si, Gyeonggi-do (KR); Erang CHO, Yongin-si, Gyeonggi-do (KR); Manseok HAN, Yongin-si, Gyeonggi-do (KR); Taejeong KIM, Yongin-si, Gyeonggi-do (KR); Joowan PYO, Yongin-si, Gyeonggi-do (KR)

(21) Appl. No.: 16/633,679

(22) PCT Filed: May 10, 2018
(86) PCT No.: PCT/KR2018/005388

§ 371 Date: Jan. 24, 2020

(30) Foreign Application Priority Data
Aug. 3, 2017 (KR) 10-2017-0098518

(51) Int. Cl. H01M 10/0568; H01M 10/0567

(52) U.S. Cl. CPC H01M 10/0568; H01M 10/0525; H01M 10/0567

(57) ABSTRACT

Provided are an electrolyte for a lithium battery and a lithium battery including the electrolyte. The electrolyte for a lithium battery includes a non-aqueous organic solvent and a lithium salt including lithium hexafluoro phosphate (LiPF₆), lithium bis(fluorosulfonyl) imide (LiFSI), and lithiumtetrafluoroborate (LiBF₄), wherein, on the basis of 1 mole (mol) of LiPF₆, the amount of LiFSI is in a range of about 0.01 mol to about 1.2 mol, and the amount of LiBF₄ is in a range of about 0.05 mol to about 0.7 mol. By using the electrolyte for a lithium battery, service life characteristics and high-temperature characteristics of the lithium battery may be improved.

### TECHNICAL FIELD

The present disclosure relates to an electrolyte for a lithium battery and a lithium battery including the electrolyte.

### BACKGROUND ART

With the development of small high-tech devices such as digital cameras, mobile devices, laptops, and computers, the demand for lithium secondary batteries as energy sources has rapidly increased. With the recent spread of hybrid electric vehicles (HEVs), plug-in hybrid electric vehicles (PHEVs), and electric vehicle (EVs), which are commonly named xEV, the development of safe lithium-ion batteries of high capacity is ongoing.

With the demand for batteries of high capacity, electrode systems of various structures are being suggested. For example, in order to provide high capacity, a silicon-based anode active material may be used in an anode. However, the volume of a silicon anode may expand and contract during the intercalation and deintercalation of lithium ions. As a charge-discharge cycle progresses, cracks may form in a silicon anode due to the volume expansion and contraction. In a lithium secondary battery, a thick film may form (e.g., on an electrode) due to the formation of a new solid electrolyte interface (SEI) and depletion of an electrolytic solution may occur, resulting in a decrease in the lifespan of the battery.

Also, when pores in the battery reduce due to a capacity increase, the internal pressure of the battery significantly increases despite the occurrence of a small amount of gas caused by dissociation of the electrolytic solution, and this becomes a problem in terms of stability. Particularly, FEC needs to be used in a high-capacity cell using a silicon-based anode for better life characteristics, but the amount of gas generated at high temperature increases. Also, a resistance increase needs to be suppressed for application to an electric vehicle, and thus a solution to this is needed.

Therefore, in order to improve electrochemical performance of a lithium battery, the optimization of various battery components as well as high-capacity active materials needs to be examined.

### DESCRIPTION OF EMBODIMENTS

### Technical Problem

Provided is an electrolyte for a lithium battery that may improve life characteristics and high-temperature characteristics of a lithium battery.

Provided is a lithium battery including the electrolyte.

### Solution to Problem

According to an aspect of the present disclosure, an electrolyte for a lithium battery includes

a non-aqueous organic solvent; and

a lithium salt including lithium hexafluoro phosphate (LiPF₆), lithium bis(fluorosulfonyl) imide (LiFSI), and lithiumtetrafluoroborate (LiBF₄), wherein

based on 1 mole (mol) of LiPF₆, an amount of LiFSI is in a range of about 0.01 mol to about 1.2 mol, and an amount of LiBF₄ is in a range of about 0.05 mol to about 0.7 mol.

According to another aspect of the present disclosure, a lithium battery includes the electrolyte.

### Advantageous Effects of Disclosure

According to one or more of embodiments of the present disclosure, an electrolyte for a lithium battery may improve life characteristics and high-temperature characteristics of a lithium battery.

### BRIEF DESCRIPTION OF DRAWINGS

FIG. 1 is a schematic view that shows a schematic structure of a lithium battery according to an embodiment.

### MODE OF DISCLOSURE

Hereinafter, one or more embodiments of the present disclosure will be described in detail.

According to an embodiment, an electrolyte for a lithium battery may include

a non-aqueous organic solvent; and

a lithium salt including lithium hexafluoro phosphate (LiPF₆), lithium bis(fluorosulfonyl) imide (LiFSI), and lithiumtetrafluoroborate (LiBF₄), wherein

based on 1 mole (mol) of LiPF₆, an amount of LiFSI is in a range of about 0.01 mol to about 1.2 mol, and an amount of LiBF₄ is in a range of about 0.05 mol to about 0.7 mol.

A lithium salt serves as a supply source of lithium ions in the lithium battery and thus enables basic operation of the lithium battery. Generally, various types of lithium salts are used in an electrolyte solution for lithium batteries, but studies related to composition of lithium salts for suppressing gas occurrence occurring at high temperature and resistance increase to improve life characteristics of a high-capacity lithium battery are not significant.

The electrolyte for a lithium battery according to an embodiment may improve life characteristics by including a 3-composition-based lithium salt, that is lithium hexafluoro phosphate (LiPF₆), lithium bis(fluorosulfonyl) imide (LiFSI), and lithiumtetrafluoroborate (LiBF₄) at amounts within predetermined ranges and may improve high-temperature characteristics such as suppressing resistance increase or gas occurrence when remained in high temperature.

In some embodiments, an amount of LiFSI in the electrolyte may be in a range of about 0.01 mol to about 1.2 mol, for example, about 0.1 mol to about 1 mol or about 0.15 mol to about 0.54 mol, based on 1 mol of LiPF₆. When the amount of LiFSI is within these ranges, life characteristics and high-temperature characteristics of the lithium battery may further improve.

In some embodiments, an amount of LiBF₄ in the electrolyte may be in a range of about 0.05 mol to about 0.7 mol, for example, about 0.08 mol to about 0.6 mol or about 0.1 mol to about 0.5 mol, based on 1 mol of LiPF₆. When the amount of LiBF₄ is within these ranges, life characteristics and high-temperature characteristics of the lithium battery may further improve.

In some embodiments, the total concentration of the lithium salt in the electrolyte may be in a range of about 0.1 M to about 5.0 M, for example, about 0.1 M to about 2.0 M or about 0.9 M to about 1.8 M. When the total concentration of the lithium salt is within these ranges, the electrolyte may have appropriate conductivity and viscosity, and thus electrolyte performance may be excellent, and lithium ions may effectively migrate.

The non-aqueous organic solvent in the electrolyte for a lithium battery may serve as a medium through which ions involved in electrochemical reactions may migrate. Examples of the non-aqueous organic solvent may include a carbonate-based compound, an ester-based compound, an ether-based compound, a ketone-based compound, an alcohol-based compound, an aprotic solvent, or a combination thereof.

Examples of the carbonate-based compound may include a chain carbonate compound or a cyclic carbonate compound; or a fluoro carbonate compound thereof; or a combination thereof.

Examples of the chain carbonate compound may include diethyl carbonate (DEC), dimethyl carbonate (DMC), dipropyl carbonate (DPC), methylpropyl carbonate (MPC), ethylpropyl carbonate (EPC), methylethyl carbonate (MEC) or a combination thereof, and examples of the cyclic carbonate compound may include ethylene carbonate (EC), propylene carbonate (PC), butylene carbonate (BC), vinylethylene carbonate (VEC), or a combination thereof.

Examples of the fluoro carbonate compound may include fluoroethylene carbonate (FEC), 4,5-difluoroethylenecarbonate, 4,4-difluoroethylenecarbonate, 4,4,5-trifluoroethylenecarbonate, 4,4,5,5-tetrafluoroethylenecarbonate, 4-fluoro-5-methylethylenecarbonate, 4-fluoro-4-methylethylenecarbonate, 4,5-difluoro-4-methylethylenecarbonate, 4,4,5-trifluoro-5-methylethylenecarbonate, trifluoromethylethylenecarbonate, or a combination thereof.

The carbonate-based compound may be a mixture of the chain and cyclic carbonate compounds. For example, when an amount of the cyclic carbonate compound is at least about 20 volume % or more based on the total volume of the non-aqueous organic solvent, cycle characteristics of the battery may significantly improve. In some embodiments, an amount of the cyclic carbonate compound may be in a range of about 20 volume % to about 70 volume % based on the total volume of the non-aqueous organic solvent.

The carbonate-based compound may be a mixture of the chain and/or cyclic carbonate compounds and the fluoro carbonate compound. The fluoro carbonate compound may improve an ion conductivity by increasing a solubility of the lithium salt and may assist facilitating formation of a thin layer on the anode. The fluoro carbonate compound may particularly improve life characteristics of high-capacity lithium batteries. In one embodiment, the fluoro carbonate compound may be fluoroethylene carbonate (FEC)

An amount of the fluoro carbonate compound may be in a range of about 10 volume % to about 50 volume %, for example, about 20 volume % to about 40 volume %, based on the total volume of the electrolyte solution. When the amount of the fluoro carbonate compound is within these ranges, a desired effect may be obtained while maintaining an appropriate viscosity.

Examples of the ester-based compound may include methylacetate, acetate, n-propylacetate, dimethylacetate, methylpropionate, ethylpropionate, γ-butyrolactone, decanolide, valerolactone, mevalonolactone, caprolactone, and methyl formate. Also, examples of the ether-based compound may include dibutyl ether, tetraglyme, diglyme, 1,2-dimethoxyethane, 1,2-diethoxyethane, ethoxymethoxyethane, 2-methyltetrahydrofuran, and tetrahydrofuran; and examples of the ketone-based compound may include cyclohexanone. Also, examples of the alcohol-based compound may include ethylalcohol and isopropyl alcohol.

Examples of the aprotic solvent may include dimethylsulfoxide, 1,2-dioxolan, sulforane, methyl sulforane, 1,3-dimethyl-2-imidazolidanone, N-methyl-2-pyrolidinone, formamide, dimethylformamide, acetonitrile, nitromethane, trimethyl phosphate, triethyl phosphate, trioctyl phosphate, and triester phosphate.

The non-aqueous organic solvent may be used alone or as a mixture of at least two selected therefrom. When the non-aqueous organic solvent is used as a mixture, the mixture ratio may be appropriately controlled in accordance with a desirable battery performance.

The electrolyte solution for lithium batteries may further include any material that is commonly used as a lithium salt in the art in addition to LiPF₆, LiFSI, and LiBF₄. Examples of the commonly used lithium salt may include at least one selected from LiCl, LiBr, Lil, LiClO₄, LiB₁₀Cl₁₀, CF₃SO₃Li, CH₃SO₃Li, C₄F₃SO₃Li, (CF₃SO₂)₂NLi, LiN(CₓF₂ₓ₊₁SO₂)(C_{y}F_{2+y}SO₂) (where x and y are each independently a natural number), CF₃CO₂Li, LiAsF₆, LiSbF₆, LiAlCl₄, LiAlF₄, lithiumchloroborate, lower aliphatic carboxylic acid lithium, lithium tetraphenyl borate, and lithium imide.

In one embodiment, the electrolyte solution may further include a sulfone compound represented by Formula 1 as an additive.

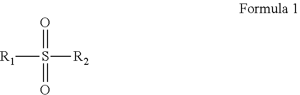

In Formula 1, at least one of R₁ and R₂ may be a fluorine atom or a C1-C12 chain hydrocarbon substituted with a fluorine atom; and the other one of R₁ and R₂ is a hydrogen atom or an unsubstituted C1-C12 chain hydrocarbon group.

For example, the chain hydrocarbon group may be a C1-C12 alkyl group or a C2-C12 alkenyl group.

Examples of the alkyl group may include a C1-C12 alkyl group such as a methyl group, an ethyl group, an n-propyl group, an isopropyl group, an n-butyl group, an isobutyl group, a sec-butyl group, an n-pentyl group, an isopentyl group, a neopentyl group, an n-hexyl group, a 3-methylhexyl group, a 2,2-dimethylpentyl group, a 2,3-dimethylpentyl, or an n-heptyl group; for example, a C1-C8 alkyl group; or a C1-C3 alkyl group.

Examples of the alkenyl group may include a C2-C12 alkenyl group such as a vinyl group, an allyl group, a butenyl group, an isopropenyl group, or an isobutenyl group; for example, a C2-C8 alkenyl group; or a C2-C4 alkenyl group.

Some or all of hydrogen atoms in the hydrocarbon group may be substituted with a fluorine atom. In Formula 1, at least one of R₁ and R₂ may be a fluorine atom or a C1-C12 chain hydrocarbon group substituted with a fluorine atom.

Examples of the sulfone compound represented by Formula 1 may include methanesulfonyl fluoride, ethanesulfonyl fluoride, propanesulfonyl fluoride, 2-propanesulfonyl fluoride, butanesulfonyl fluoride, 2-butane sulfonyl fluoride, hexanesulfonyl fluoride, octanesulfonyl fluoride, decanesulfonyl fluoride, dodecanesulfonyl fluoride, cyclohexanesulfonyl fluoride, trifluoromethanesulfonyl fluoride, perfluoroethanesulfonyl fluoride, perfluoropropanesulfonyl fluoride, perfluorobutanesulfonyl fluoride, ethene sulfonyl fluoride, 1-propene-1-sulfonyl fluoride, 2-propene-1-sulfonyl fluoride, 2-methoxy-ethanesulfonyl fluoride, or 2-ethoxy-ethanesulfonyl fluoride.

The sulfone compound may be used alone or as combination of at least two selected therefrom.

An amount of the sulfone compound in the electrolyte solution may be in a range of about 1 wt % to about 10 wt % based on 100 wt % of the total weight of the lithium salt, solvent, and additive. When the amount of the sulfone compound is within this range, increase in and gas occurrence of a lithium battery at a high-temperature may be effectively suppressed.

The electrolyte solution for lithium batteries may further include other additives to improve cycle characteristics by assisting formation of a stable solid electrolyte interface (SEI) or film on a surface of an electrode.

Examples of the additive may include tris(trimethylsilyl) phosphate (TMSPa), lithium difluorooxalato borate (LiFOB), vinylene carbonate (VC), propane sultone (PS), succinonitrile (SN), a silane compound having a functional group capable of forming a siloxane bond with acryl, amino, epoxy, methoxy, ethoxy, or vinyl, and a silazane compound such as hexamethyldisilazane. The additive may be added alone or as a combination of at least two additives.

An amount of the additive may be in a range of about 0.01 wt % to about 10 wt % based on 100 wt % of the total weight of the lithium salt, solvent, and additive. For example, an amount of the additive may be in a range of about 0.05 wt % to about 10 wt %, for example, about 0.1 wt % to about 5 wt %, or about 0.5 wt % to about 4 wt % based on 100 wt % of the total weight of the lithium salt, solvent, and additive. However, an amount is not particularly limited as long as it does not significantly reduce a capacity retention rate improving effect of the lithium battery according to inclusion of the electrolyte.

In some embodiments, the lithium battery may include a cathode, and anode, and the electrolyte for a lithium battery disposed between the cathode and the anode. In some embodiments, the lithium battery may be manufactured by using a preparation method commonly known in the art.

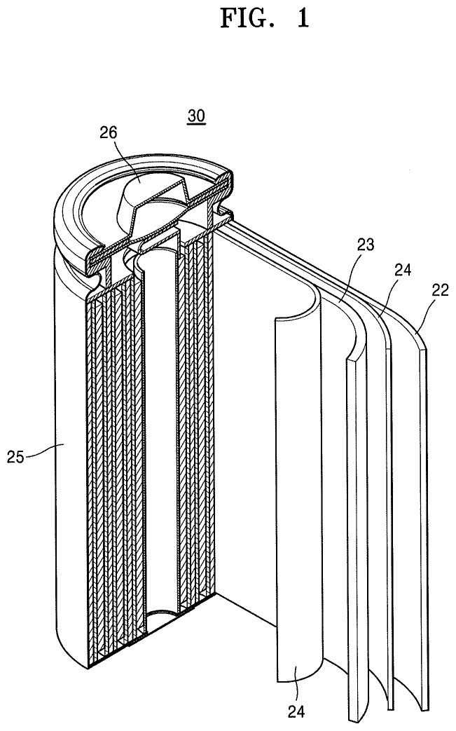

FIG. 1 is a schematic view of a typical structure of a lithium battery 30 according to an embodiment.

Referring to FIG. 1, the lithium battery 30 includes a cathode 23, an anode 22, and a separator 24 disposed between the cathode 23 and the anode 22. In some embodiments, the cathode 23, the anode 22, and the separator 24 may be wound or folded, and then sealed in a battery case 25. In some embodiments, the battery case 25 may be filled with the electrolyte and sealed with a cap assembly 26, thereby completing the manufacture of the lithium battery 30. In some embodiments, the battery case 25 may be a coin type, a rectangular type, or a thin-film type. For example, the lithium battery 30 may be a thin-film type battery.

The cathode 23 includes a cathode current collector and a cathode active material layer on the cathode current collector.

A thickness of the cathode current collector may generally be in a range of about 3 μm to about 500 μm. Examples of a material for the current collector are not particularly limited as long as they do not cause a chemical change to a battery. Examples of the material for the current collector may include copper, stainless steel, aluminum, nickel, titanium, calcined carbon, copper or stainless steel that is surface-treated with carbon, nickel, titanium, or silver, and an aluminum-cadmium alloy. The current collector may have uneven micro structures at its surface to enhance a binding force with the cathode active material. Also, the current collector may be used in various forms including a film, a sheet, a foil, a net, a porous body, a foaming body, or a non-woven body.

The cathode active material layer may include a cathode active material, a binder, and, selectively, a conducting agent.

The cathode active material may be formed of any material available in the art, for example, may be a lithium-containing metal oxide. In some embodiments, the cathode active material may be at least one of a composite oxide of lithium with a metal selected from among Co, Mn, Ni, and a combination thereof. In some embodiments, the cathode active material may be a compound represented by one of the following formulae:

LiₐA_{1-b}B_{b}D₂ (where 0.90≤a≤1, and 0≤b≤0.5); LiₐE_{1-b}B_{b}O_{2-c}D_{c} (where 0.90≤a≤1, 0≤b≤0.5, and 0≤c≤0.05); LiE_{2-b}B_{b}O_{4-c}D_{c} (where 0≤b≤0.5, and 0≤c≤0.05); LiₐNi_{1-b-c}Co_{b}B_{c}D_{α} (where 0.90≤a≤1, 0≤b≤0.5, 0≤c≤0.05, and 0<α≤2); LiₐN_{1-b-c}Co_{b}B_{c}O_{2-α}F_{α} (where 0.90≤a≤1, 0≤b≤0.5, 0≤c≤0.05, and 0<α<2); LiₐN_{1-b-c}Co_{b}B_{c}O_{2-α}F₂ (where 0.90≤a≤1, 0≤b≤0.5, 0≤c≤0.05, and 0<α<2); LiₐNi_{1-b-c}Mn_{b}B_{c}D_{α} (where 0.90≤a≤1, 0≤b 0.5, 0≤c≤0.05, and 0<α≤2); LiₐNi_{1-b-c}Mn_{b}B_{c}O_{2-α}F_{α} (where 0.90≤a≤1, 0≤b≤0.50, 0≤c≤0.05, and 0<α<2); LiₐN_{1-b-c}Mn_{b}B_{c}O_{2-α}F₂ (where 0.90≤a≤1, 0≤b 0.5, 0≤c≤0.05, and 0<α<2); LiₐNi_{b}E_{c}G_{d}O₂ (where 0.90≤a≤1, 0≤b≤0.9, 0≤c≤0.5, and 0.001≤d≤0.1); LiₐNi_{b}Co_{c}Mn_{d}GeO₂ (where 0.90≤a≤1, 0≤b≤0.9, 0≤c≤0.5, 0≤d≤0.5, and 0.001≤e≤0.1); LiₐNiG_{b}O₂ (where 0.90≤a≤1, and 0.001≤b≤0.1); LiₐCoG_{b}O₂ (where 0.90≤a≤1, and 0.001≤b≤0.1); LiₐMnG_{b}O₂ (where 0.90≤a≤1, and 0.001≤b≤0.1); LiaMn₂G_{b}O₄ (where 0.90≤a≤1, and 0.001≤b≤0.1); QO₂; QS₂; LiQS₂; V₂O₅; LiV₂O₅; LiIO₂; LiNiVO₄; Li_{(3-f)}J₂(PO₄)₃ (where 0≤f≤2); Li_{(3-f)}Fe₂(PO₄)₃ (where 0≤f≤2); and LiFePO₄.

In the formulae above, A may be selected from nickel (Ni), cobalt (Co), manganese (Mn), and combinations thereof; B may be selected from aluminum (Al), nickel (Ni), cobalt (Co), manganese (Mn), chromium (Cr), iron (Fe), magnesium (Mg), strontium (Sr), vanadium (V), a rare earth element, and combinations thereof; D may be selected from oxygen (O), fluorine (F), sulfur (S), phosphorus (P), and combinations thereof; E may be selected from cobalt (Co), manganese (Mn), and combinations thereof; F may be selected from fluorine (F), sulfur (S), phosphorus (P), and combinations thereof; G may be selected from aluminum (Al), chromium (Cr), manganese (Mn), iron (Fe), magnesium (Mg), lanthanum (La), cerium (Ce), strontium (Sr), vanadium (V), and combinations thereof; Q may be selected from titanium (Ti), molybdenum (Mo), manganese (Mn), and combinations thereof; I may be selected from chromium (Cr), vanadium (V), iron (Fe), scandium (Sc), yttrium (Y), and combinations thereof; and J may be selected from vanadium (V), chromium (Cr), manganese (Mn), cobalt (Co), nickel (Ni), copper (Cu), and combinations thereof.

In some embodiments, the cathode active material may be LiCO₂, LiMnₓO₂ₓ (where x=1 or 2), LiN₁₋ₓMnₓO₂ₓ (where 0<x<1), LiN_{1-x-y}CoₓMnyO₂ (where 0≤x≤0.5 and 0≤y≤0.5), or FePO₄.

The compounds listed above as cathode active materials may have a surface coating layer (hereinafter, also referred to as “coating layer”). Alternatively, a mixture of a compound without a coating layer and a compound having a coating layer, the compounds being selected from the compounds listed above, may be used. In some embodiments, the coating layer may include at least one compound of a coating element selected from the group consisting of oxide, hydroxide, oxyhydroxide, oxycarbonate, and hydroxycarbonate of the coating element. In some embodiments, the compounds for the coating layer may be amorphous or crystalline. In some embodiments, the coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof. In some embodiments, the coating layer may be formed using any method that does not adversely affect the physical properties of the cathode active material when a compound of the coating element is used. For example, the coating layer may be formed using a spray coating method, or a dipping method. The coating methods may be well understood by one of ordinary skill in the art, and thus a detailed description thereof will be omitted.

The binder may attach particles of the cathode active material to one another and may attach the cathode active material to the cathode current collector. Examples of the binder may include polyvinyl alcohol, carboxymethyl cellulose, hydroxypropyl cellulose, diacetyl cellulose, polyvinylchloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, and nylon, but embodiments are not limited thereto.

The conducting agent may be a suitable electron conducting material that provides conductivity to the electrode and that does not induce chemical change in the battery. Examples of the conducting agent may include natural graphite, artificial graphite, carbon black, acetylene black, Ketjen black, carbon fiber, metal powder or metal fiber of copper, nickel, aluminum, silver, and conductive materials, such as polyphenylene derivatives, which may be used alone or in a combination of at least two thereof.

The anode 22 may include an anode current collector and an anode active material formed on the anode current collector.

A thickness of the anode current collector may generally be in a range of about 3 μm to about 500 μm. Examples of a material for the anode collector are not particularly limited as long as they do not cause a chemical change to a battery. Examples of the material for the current collector may include copper, stainless steel, aluminum, nickel, titanium, calcined carbon, copper or stainless steel that is surface-treated with carbon, nickel, titanium, or silver, and an aluminum-cadmium alloy. The current collector may have uneven micro structures at its surface to enhance a binding force with the anode active material. Also, the current collector may be used in various forms including a film, a sheet, a foil, a net, a porous body, a foaming body, or a non-woven body.

The anode active material layer may include an anode active material, a binder, and, selectively, a conducting agent.

The anode active material may include the silicon-based anode active material described above.

The anode active material layer may further include other common anode active material in addition to the silicon-based anode active material.

The common anode active material may be formed of any material that is commonly used as an anode active material in the art. Examples of the anode active material may include a lithium metal, a metal alloyable with lithium, a transition metal oxide, a material capable of doping and de-doping lithium, and a material capable of reversibly intercalating and deintercalating lithium ions. The anode active material may be a mixture or a combination of at least two selected there above.

The alloy of lithium metal may be an alloy of lithium and one metal selected from the group consisting of Na, K, Rb, Cs, Fr, Be, Mg, Ca, Sr, Si, Sb, Pb, In, Zn, Ba, Ra, Ge, Al, and Sn.

Examples of the transition metal oxide may include a tungsten oxide, a molybdenum oxide, a titanium oxide, a lithium titanium oxide, a vanadium oxide, and a lithium vanadium oxide

Examples of the material capable of doping and de-doping lithium may include Sn; SnO₂; and a Sn—Y alloy (where, Y is an alkali metal, an alkali earth metal, a Group 11 element, a Group 12 element, a Group 13 element, a Group 14 element, a Group 15 element, a Group 16 element, a transition metal, a rare-earth element, or a combination thereof, but not Sn). In some embodiments, Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or combinations thereof.

The material capable of reversibly intercalating and deintercalating lithium ions may be any one of various carbon-based materials that are generally used in a lithium battery. Examples of the material capable of reversibly intercalating and deintercalating lithium ions may include crystalline carbon, amorphous carbon, and a mixture thereof. Examples of the crystalline carbon include natural graphite, artificial graphite, expanded graphite, graphene, fullerene soot, carbon nanotubes, and carbon fibers. Examples of the amorphous carbon include soft carbon (carbon calcined at a relatively low temperature) or hard carbon, mesophase pitch carbide, and calcined cokes. The carbon-based anode active material may be in a form of a sphere shape, a plate shape, a fibrous shape, a tube shape, or a powder form.

The binder may attach particles of the anode active material to one another and attaches the anode active material to a current collector. Examples of the binder may include polyvinyl alcohol, carboxymethyl cellulose, hydroxypropyl cellulose, polyvinylchloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, and nylon, but embodiments are not limited thereto.

The conducting agent may be formed of an electron conducting material that provides conductivity to the electrode and that does not induce chemical change in the battery. Examples of the conducting agent may include natural graphite; artificial graphite; carbon black; acetylene black; Ketjen black; carbon fiber; metal powder or metal fiber of copper, nickel, aluminum, silver; conductive materials, such as polyphenylene derivatives; or a mixture thereof.

The cathode 23 and the anode 22 may each be prepared by preparing an active material composition by mixing an active material, a conducting agent, and a binder in a solvent and coating the composition on a current collector.

The electrode preparation method may be well understood by one of ordinary skill in the art, and thus a detailed description thereof will be omitted. Examples of the solvent may include N-methylpyrrolidone (NMP), acetone, or water, but embodiments are not limited thereto.

The cathode 23 and the anode 22 may be separated by the separator 24. The separator 24 may be formed of a material that is commonly used as a separator in a lithium battery. For example, the material for the separator 24 may have low resistance to ion migration of the electrolyte and have an excellent electrolyte solution holding ability. The separator 24 may be a single layer or multiple layers. For example, the separator 24 may be formed of glass fiber, polyester, Teflon, polyethylene, polypropylene, polytetrafluoroethylene (PTFE), or a combination thereof, which may have a non-woven form or a woven form. A pore diameter of the separator 24 may be in a range of about 0.01 μm to about 10 μm, and a thickness of the separator 24 is generally in a range of about 3 μm to about 100 μm.

The electrolyte may be injected to a space formed by the separation of the cathode 23 and the anode 22 by the separator 24.

The lithium battery may be suitable for devices requiring high capacity, high output, and high temperature driving such as an electric vehicle in addition to conventional usage in mobile phones and portable computers. The lithium battery may combine with conventional internal combustion engines, fuel cells, or super capacitors and then used in a hybrid vehicle. In addition, the lithium battery can be used for all other applications requiring high output, high voltage, and high temperature driving.

One or more embodiments will now be described in more detail with reference to the following examples. However, these examples are not intended to limit the scope of the one or more embodiments.

### Example

Room-temperature life characteristics and high-temperature characteristics of electrolyte solutions and lithium batteries prepared in examples and comparative examples below were evaluated as follows.

### Evaluation Example 1: Evaluation of Room-Temperature Life Characteristics

At a temperature of 25° C., each of coin full cells prepared in Examples and Comparative Examples was charged at a constant current of 0.2 C rate until a voltage was 4.2 V and then discharged at a constant current of 0.2 C rate until a voltage was 2.8 V. Subsequently, the full cells were each charged at a constant current of 0.5 C rate until a voltage was 4.2 V and then charged in a constant voltage mode until a current was 0.05 C rate while maintaining the voltage at 4.2 V. Next, the full cells were each discharged at a constant current of 0.5 C rate until a voltage was 2.8 V. (Formation process)

At a temperature of 25° C., each of the coin full cells that underwent the formation process was charged at a constant current of 1.0 C rate until a voltage was 4.2 V, and then the current was cut-off at a current of 0.05 C rate while maintaining the voltage at 4.2 V in a constant voltage mode. Next, the full cells were each discharged at a constant current of 1.0 C rate until a voltage was 2.8 V, and this cycle was repeated up to the 300th cycle.

A capacity retention rate (%) at the 300^{th} cycle of each of the coin full cells is defined as shown in Equation 1.

Capacity retention rate at 300^{th} cycle[%]=[Discharge capacity at 300^{th}, cycle/discharge capacity at 1^{st} cycle]×100 Equation 1

### Evaluation Example 2: Evaluation of High-Temperature Characteristics

At a temperature of 25° C., each of coin full cells prepared in Examples 1 to 17 and Comparative Examples 1 to 7 was charged at a constant current of 0.2 C rate until a voltage was 4.2 V and then discharged at a constant current of 0.2 C rate until a voltage was 2.8 V. Subsequently, the full cells were each charged at a constant current of 0.5 C rate until a voltage was 4.2 V and then charged in a constant voltage mode until a current was 0.05 C rate while maintaining the voltage at 4.2 V. Next, the full cells were each discharged at a constant current of 0.5 C rate until a voltage was 2.8 V. (Formation process)

The coin full cells that underwent the formation process was stored in a high-temperature chamber at 60° C. for 30 days, and then capacity retention rates and direct current internal resistances (DCIRs) of the full cells for the storing period were measured. Resistance increase rates with respect to initial resistances were calculated through the measurement of DCIRs.

Also, an amount of internal gas occurrence was measured by using a gas capturing jig so that gas occurred from the full cell after boring a hole at the bottom of each of the coin full cells of Examples 1 to 17 and Comparative Examples 1 to 7 stored at 60° C. for 30 days was not released to the outside, and using gas chromatography (GC) connected to the full cell.

### Comparative Example 1

(1) Preparation of electrolyte

An electrolyte was prepared by dissolving LiPF₆ as a lithium salt in a solvent mixture including ethylene carbonate (EC), ethylmethyl carbonate (EMC), and dimethyl carbonate (DMC) (where a volume ratio of EC:EMC:DEC=20:40:40) so that a concentration of LiPF₆ was 1.15 M. In the electrolyte, 7 wt % of fluoroethylene carbonate (FEC) was mixed as an additive based on the total weight 100 wt % of the lithium salt, solvent, and additive.

(2) Preparation of Coin Full Cell

18650 type coin full cells were prepared by using the electrolyte.

A cathode active material powder having a composition of LiN_{1/3}Co_{1/3}Mn_{1/3}O₂, a carbon conducting agent (Super-P, available from Timcal Ltd.), and polyvinylidene fluoride (PVDF) as a binder were mixed at a weight ratio of 90:5:5. In order to control a viscosity of the mixture, N-methylpyrrolidone (NMP) as a solvent was added to the mixture so that a solid content of the mixture was 60 wt %, and thus a cathode slurry was prepared. The cathode slurry was coated at a thickness of about 40 μm on an aluminum foil having a thickness of 15 μm. The resultant was dried at room temperature, dried again at a temperature of 120° C., and then roll-pressed to prepare a cathode.

Artificial graphite as an anode active material, styrene-butadiene rubber, and carboxymethyl cellulose were mixed at a weight ratio of 90:5:5. In order to control a viscosity of the mixture, NMP as a solvent was added to the mixture so that a solid content of the mixture was 60 wt %, and thus an anode slurry was prepared. The cathode slurry was coated at a thickness of about 40 μm on a copper foil having a thickness of 10 μm. The resultant was dried at room temperature, dried again at a temperature of 120° C., and then roll-pressed to prepare an anode.

A polyethylene separator having a thickness of 20 μm as a separator and the electrolyte were used to prepare a coin full cell of 18650 type.

### Comparative Example 2

An electrolyte and a coin full cell were prepared in the same manner as in Comparative Example 1, except that LiPF₆ and LiFSI as lithium salts were added to the electrolyte at concentrations of 0.80 M and 0.35 M, respectively.

### Comparative Example 3

An electrolyte and a coin full cell were prepared in the same manner as in Comparative Example 1, except that LiPF₆ and LiBF₄ as lithium salts were added to the electrolyte at concentrations of 1.0 M and 0.15 M, respectively.

### Comparative Example 4

An electrolyte and a coin full cell were prepared in the same manner as in Comparative Example 1, except that LiFSI and LiBF₄ as lithium salts were added to the electrolyte at concentrations of 1.0 M and 0.15 M, respectively.

### Comparative Example 5

An electrolyte and a coin full cell were prepared in the same manner as in Comparative Example 1, except that LiPF₆, LiBF₄, and lithium bis(trifluoromethane sulfonyl) imide (LiTFS) as lithium salts were added to the electrolyte at concentrations of 0.8 M, 0.15 M, and 0.35 M, respectively.

### Example 1

An electrolyte and a coin full cell were prepared in the same manner as in Comparative Example 1, except that LiPF₆, LiFSI, and LiBF₄ as lithium salts were added to the electrolyte at concentrations of 0.65 M, 0.10 M, and 0.15 M, respectively.

### Example 2

An electrolyte and a coin full cell were prepared in the same manner as in Comparative Example 1, except that LiPF₆, LiFSI, and LiBF₄ as lithium salts were added to the electrolyte at concentrations of 0.65 M, 0.35 M, and 0.15 M, respectively.

### Example 3

An electrolyte and a coin full cell were prepared in the same manner as in Comparative Example 1, except that LiPF₆, LiFSI, and LiBF₄ as lithium salts were added to the electrolyte at concentrations of 0.65 M, 0.70 M, and 0.15 M, respectively.

### Comparative Example 6

An electrolyte and a coin full cell were prepared in the same manner as in Comparative Example 1, except that LiPF₆, LiFSI, and LiBF₄ as lithium salts were added to the electrolyte at concentrations of 0.65 M, 0.90 M, and 0.15 M, respectively.

### Example 4

An electrolyte and a coin full cell were prepared in the same manner as in Comparative Example 1, except that LiPF₆, LiFSI, and LiBF₄ as lithium salts were added to the electrolyte at concentrations of 0.65 M, 0.35 M, and 0.15 M, respectively.

### Example 5

An electrolyte and a coin full cell were prepared in the same manner as in Comparative Example 1, except that LiPF₆, LiFSI, and LiBF₄ as lithium salts were added to the electrolyte at concentrations of 0.65 M, 0.35 M, and 0.30 M, respectively.

### Comparative Example 7

An electrolyte and a coin full cell were prepared in the same manner as in Comparative Example 1, except that LiPF₆, LiFSI, and LiBF₄ as lithium salts were added to the electrolyte at concentrations of 0.65 M, 0.35 M, and 0.50 M, respectively.

### Example 6

An electrolyte and a coin full cell were prepared in the same manner as in Example 2, except that a silane compound represented by Formula 2 at an amount of 1 wt % based on the total weight 100 wt % of the lithium salt, solvent, and additive was added to the electrolyte prepared in Example 2 in addition to FEC as an additive.

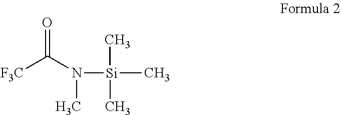

### Example 7

An electrolyte and a coin full cell were prepared in the same manner as in Example 2, except that 1,3-propane sultone at an amount of 1 wt % based on the total weight 100 wt % of the lithium salt, solvent, and additive was added to the electrolyte prepared in Example 2 in addition to FEC as an additive.

### Example 8

An electrolyte and a coin full cell were prepared in the same manner as in Example 3, except that ethylene sulfate at an amount of 1 wt % based on the total weight 100 wt % of the lithium salt, solvent, and additive was added to the electrolyte prepared in Example 2 in addition to FEC as an additive.

### Example 9

An electrolyte and a coin full cell were prepared in the same manner as in Example 2, except that 1,3-propene sultone at an amount of 1 wt % based on the total weight 100 wt % of the lithium salt, solvent, and additive was added to the electrolyte prepared in Example 2 in addition to FEC as an additive.

### Example 10

An electrolyte and a coin full cell were prepared in the same manner as in Example 2, except that a sulfone compound (hereinafter, also referred to as “SF compound”) represented by Formula 6 at an amount of 10 wt % based on the total weight 100 wt % of the lithium salt, solvent, and additive was added to the electrolyte prepared in Example 2 without adding FEC as an additive thereto.

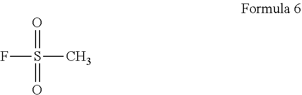

### Example 11

An electrolyte and a coin full cell were prepared in the same manner as in Example 10, except that that an amount of the SF compound was 7 wt %.

### Example 12

An electrolyte and a coin full cell were prepared in the same manner as in Example 10, except that that an amount of the SF compound was 5 wt %.

### Example 13

An electrolyte and a coin full cell were prepared in the same manner as in Example 10, except that that an amount of the SF compound was 3 wt %.

### Example 14

An electrolyte and a coin full cell were prepared in the same manner as in Example 10, except that that an amount of the SF compound was 1 wt %

### Example 15

An electrolyte and a coin full cell were prepared in the same manner as in Example 2, except that 4 wt % of FEC and 3 wt % of the SF compound represented by Formula 6 as additives based on the total weight 100 wt % of the lithium salt, solvent, and additive were added as additives to the electrolyte prepared in Example 2.

### Example 16

An electrolyte and a coin full cell were prepared in the same manner as in Example 15, except that propane sultone (PS) represented by Formula 3 at an amount of 1 wt % as an additive was added to the electrolyte of Example 15 in addition to FEC and the SF compound represented by Formula 6.

### Example 17

An electrolyte and a coin full cell were prepared in the same manner as in Example 15, except that ESA represented by Formula 4 at an amount of 1 wt % as an additive was added to the electrolyte of Example 15 in addition to FEC and the SF compound represented by Formula 6.

The electrolyte compositions and the results of evaluations of characteristics of the electrolytes and the coin full cells prepared in Comparative Examples 1 to 7 and Examples 1 to 17 are all shown in Table 1.

TABLE 1

| | | | | | | | Life | | | |
|---|---|---|---|---|---|---|---|---|---|---|
| | | | | | | | at 25 | Stored at 60° C. (for 30 days) | | |
| | | | | | | | ° C. | Capacity | Resistance | Amount of |
| | | | | | | Initial | 300^{th} | retention | increase | gas |
| Example | Lithium salt | | | | | resistance | cycle | rate | rate | occurrence |
| No. | LiPF6 | LiFSl | LiBF4 | LiTFSl | Additive | mΩ | % | % | % | ml |
| Comparative | 1.15 | | | | FEC 7.0 | 265 | 54 | 80 | 143 | 0.58 |
| Example 1 | | | | | | | | | | |
| Comparative | 0.8 | 0.35 | | | FEC 7.0 | 252 | 69 | 85 | 132 | 0.45 |
| Example 2 | | | | | | | | | | |
| Comparative | 1 | | 0.15 | | FEC 7.0 | 264 | 61 | 82 | 140 | 0.3 |
| Example 3 | | | | | | | | | | |
| Comparative | | 1 | 0.15 | | FEC 7.0 | 258 | 33 | 59 | 168 | 0.97 |
| Example 4 | | | | | | | | | | |
| Comparative | 0.8 | | 0.15 | 0.35 | FEC 7.0 | 270 | 65 | 80 | 139 | 0.4 |
| Example 5 | | | | | | | | | | |
| Example 1 | 0.65 | 0.1 | 0.15 | | FEC 7.0 | 247 | 68 | 86 | 128 | 0.25 |
| Example 2 | 0.65 | 0.35 | 0.15 | | FEC 7.0 | 251 | 73 | 88 | 121 | 0.29 |
| Example 3 | 0.65 | 0.7 | 0.15 | | FEC 7.0 | 260 | 74 | 86 | 124 | 0.4 |
| Comparative | 0.65 | 0.9 | 0.15 | | FEC 7.0 | 262 | 45 | 63 | 154 | 0.86 |
| Example 6 | | | | | | | | | | |
| Example 4 | 0.65 | 0.35 | 0.05 | | FEC 7.0 | 244 | 70 | 86 | 123 | 0.37 |
| Example 5 | 0.65 | 0.35 | 0.3 | | FEC 7.0 | 264 | 74 | 86 | 122 | 0.27 |
| Comparative | 0.65 | 0.35 | 0.5 | | FEC 7.0 | 281 | 69 | 79 | 123 | 0.24 |
| Example 7 | | | | | | | | | | |
| Example 6 | 0.65 | 0.35 | 0.15 | | FEC | 250 | 76 | 88 | 118 | 0.2 |
| | | | | | 7.0 + Silane | | | | | |
| | | | | | compound | | | | | |
| | | | | | 1.0 | | | | | |
| Example 7 | 0.65 | 0.35 | 0.15 | | FEC 7.0 + PS | 255 | 75 | 90 | 112 | 0.13 |
| | | | | | 1.0 | | | | | |
| Example 8 | 0.65 | 0.35 | 0.15 | | FEC | 254 | 76 | 89 | 114 | 0.14 |
| | | | | | 7.0 + ESA 1.0 | | | | | |
| Example 9 | 0.65 | 0.35 | 0.15 | | FEC | 267 | 68 | 90 | 105 | 0.11 |
| | | | | | 7.0 + PRS 1.0 | | | | | |
| Example 10 | 0.65 | 0.35 | 0.15 | | SF | 259 | 70 | 84 | 125 | 0.13 |
| | | | | | compound | | | | | |
| | | | | | 10.0 | | | | | |
| Example 11 | 0.65 | 0.35 | 0.15 | | SF | 248 | 78 | 91 | 108 | 0.11 |
| | | | | | compound | | | | | |
| | | | | | 7.0 | | | | | |
| Example 12 | 0.65 | 0.35 | 0.15 | | SF 5.0 | 241 | 79 | 91 | 107 | 0.11 |
| Example 13 | 0.65 | 0.35 | 0.15 | | SF | 237 | 80 | 91 | 105 | 0.12 |
| | | | | | compound | | | | | |
| | | | | | 3.0 | | | | | |
| Example 14 | 0.65 | 0.35 | 0.15 | | SF | 232 | 74 | 85 | 112 | 0.15 |
| | | | | | compound | | | | | |
| | | | | | 1.0 | | | | | |
| Example 15 | 0.65 | 0.35 | 0.15 | | FEC 4.0 + SF | 246 | 82 | 92 | 108 | 0.14 |
| | | | | | compound | | | | | |
| | | | | | 3.0 | | | | | |
| Example 16 | 0.65 | 0.35 | 0.15 | | FEC 4.0 + PS | 250 | 81 | 92 | 102 | 0.07 |
| | | | | | 1.0 + SF | | | | | |
| | | | | | compound | | | | | |
| | | | | | 3.0 | | | | | |
| Example 17 | 0.65 | 0.35 | 0.15 | | FEC | 247 | 82 | 92 | 103 | 0.09 |
| | | | | | 4.0 ++ ESA | | | | | |
| | | | | | 1.0 + SF | | | | | |
| | | | | | compound | | | | | |
| | | | | | 3.0 | | | | | |

As shown in Table 1, combination of lithium salts was exhibited better performance in the case of using 3 compositions, which are LiPF₆, LiFSI, and LiBF₄, than in other cases not using any of the 3 compositions. The results are shown again in Table 2.

TABLE 2

| | | | | | | | Life at | Stored at 60° C. (for 30 days) | | |
|---|---|---|---|---|---|---|---|---|---|---|
| | | | | | | | 25° C. | Capacity | | Amount of |
| | | | | | | Initial | 300^{th} | retention | Resistance | gas |
| Example | Lithium salt | | | | | resistance | cycle | rate | increase rate | occurrence |
| No. | LiPF₆ | LiFSl | LiBF₄ | LiTFSl | Additive | mΩ | % | % | % | ml |
| Comparative | 1.15 | | | | FEC | 265 | 54 | 80 | 143 | 0.58 |
| Example 1 | | | | | 7.0 | | | | | |
| Comparative | 0.8 | 0.35 | | | FEC | 252 | 69 | 85 | 132 | 0.45 |
| Example 2 | | | | | 7.0 | | | | | |
| Comparative | 1 | | 0.15 | | FEC | 264 | 61 | 82 | 140 | 0.3 |
| Example 3 | | | | | 7.0 | | | | | |
| Comparative | | 1 | 0.15 | | FEC | 258 | 33 | 59 | 168 | 0.97 |
| Example 4 | | | | | 7.0 | | | | | |
| Comparative | 0.8 | | 0.15 | 0.35 | FEC | 270 | 65 | 80 | 139 | 0.4 |
| Example 5 | | | | | 7.0 | | | | | |
| Example 1 | 0.65 | 0.1 | 0.15 | | FEC | 247 | 68 | 86 | 128 | 0.25 |
| | | | | | 7.0 | | | | | |

In order to confirm influence of an amount of LiFSI, the amount of LiFSI was varied while amounts of LiPF₆ and LiBF₄ were fixed. Trade-offs of the battery performance occurred as room-temperature life characteristics and high-temperature characteristics of the battery were rapidly deteriorated. The results are shown again in Table 3. Amounts of LiFSI prepared in Examples 1 to 3 are in a range of about 0.1 mol to about 1.2 mol when converted based on 1 mol of LiPF₆.

TABLE 3

| | | | | | | | Life at | Stored at 60° C. (for 30 days) | | |
|---|---|---|---|---|---|---|---|---|---|---|
| | | | | | | | 25° C. | Capacity | | Amount of |
| Example | Lithium salt | | | | | Initial | 300^{th} | retention | Resistance | gas |
| No. | LiPF₆ | LiFSl | LiBF₄ | LiTFSl | Additive | resistance | cycle | rate | increase rate | occurrence |
| Example 1 | 0.65 | 0.1 | 0.15 | | FEC | 247 | 68 | 86 | 128 | 0.25 |
| | | | | | 7.0 | | | | | |
| Example 2 | 0.65 | 0.35 | 0.15 | | FEC | 251 | 73 | 88 | 121 | 0.29 |
| | | | | | 7.0 | | | | | |
| Example 3 | 0.65 | 0.7 | 0.15 | | FEC | 260 | 74 | 86 | 124 | 0.4 |
| | | | | | 7.0 | | | | | |
| Comparative | 0.65 | 0.9 | 0.15 | | FEC | 262 | 45 | 63 | 154 | 0.86 |
| Example 6 | | | | | 7.0 | | | | | |

When amounts of LiPF₆ and LiFSI are fixed, and an amount of LiBF₄ was varied based on Example 2 in which the battery appeared to be excellent in terms of its room-temperature life characteristics and amount of gas occurrence, the room-temperature life characteristics and high-temperature capacity retention rate were somewhat deteriorated when a concentration of LiBF₄ was about 0.5 M or higher. The results are shown again in Table 4. Amounts of LiBF₄ prepared in Examples 1, 4, and 5 are in a range of about 0.05 mol to about 0.7 mol when converted based on 1 mol of LiPF₆.

TABLE 4

| | | | | | | | Life at | Stored at 60° C. (for 30 days) | | |
|---|---|---|---|---|---|---|---|---|---|---|
| | | | | | | | 25° C. | Capacity | | Amount of |
| Example | Lithium salt | | | | | Initial | 300^{th} | retention | Resistance | gas |
| No. | LiPF₆ | LiFSl | LiBF₄ | LiTFSl | Additive | resistance | cycle | rate | increase rate | occurrence |
| Example 2 | 0.65 | 0.35 | 0.15 | | FEC | 251 | 73 | 88 | 121 | 0.29 |
| | | | | | 7.0 | | | | | |
| Example 4 | 0.65 | 0.35 | 0.05 | | FEC | 244 | 70 | 86 | 123 | 0.37 |
| | | | | | 7.0 | | | | | |
| Example 5 | 0.65 | 0.35 | 0.3 | | FEC | 264 | 74 | 86 | 122 | 0.27 |
| | | | | | 7.0 | | | | | |
| Comparative | 0.65 | 0.35 | 0.5 | | FEC | 281 | 69 | 79 | 123 | 0.24 |
| Example 7 | | | | | 7.0 | | | | | |

Also, it may be known that performance of the battery improved when various additives were mixed to the 3-composition lithium salt including LiPF₆, LiFSI, and LiBF₄. The results are shown again in Table 5.

TABLE 5

| | | | | | | | Life at | Stored at 60° C. (for 30 days) | | |
|---|---|---|---|---|---|---|---|---|---|---|
| | | | | | | | 25° C. | Capacity | | Amount of |
| Example | Lithium salt | | | | | Initial | 300^{th} | retention | Resistance | gas |
| No. | LiPF6 | LiFSl | LiBF4 | LiTFSl | Additive | resistance | cycle | rate | increase rate | occurrence |
| Example | 0.65 | 0.35 | 0.15 | | FEC 7.0 | 251 | 73 | 88 | 121 | 0.29 |
| 2 | | | | | | | | | | |
| Example | 0.65 | 0.35 | 0.15 | | FEC | 250 | 76 | 88 | 118 | 0.2 |
| 6 | | | | | 7.0 + Silane | | | | | |
| | | | | | compound | | | | | |
| | | | | | 1.0 | | | | | |
| Example | 0.65 | 0.35 | 0.15 | | FEC 7.0 + PS | 255 | 75 | 90 | 112 | 0.13 |
| 7 | | | | | 1.0 | | | | | |
| Example | 0.65 | 0.35 | 0.15 | | FEC | 254 | 76 | 89 | 114 | 0.14 |
| 8 | | | | | 7.0 + ESA 1.0 | | | | | |
| Example | 0.65 | 0.35 | 0.15 | | FEC | 267 | 68 | 90 | 105 | 0.11 |
| 9 | | | | | 7.0 + PRS 1.0 | | | | | |

It was confirmed that high-temperature characteristics improved while maintaining room-temperature life characteristics when a sulfone compound is used instead of FEC which is used in a high-capacity lithium battery as an additive in addition to the 3-composition-based lithium salt including LiPF₆, LiFSI, and LiBF₄. The results are shown again in Table 6.

TABLE 6

| | | | | | | | Life at | Stored at 60° C. (for 30 days) | | |
|---|---|---|---|---|---|---|---|---|---|---|
| | | | | | | | 25° C. | Capacity | | Amount of |
| Example | Lithium salt | | | | | Initial | 300^{th} | retention | Resistance | gas |
| No. | LiPF₆ | LiFSl | LiBF₄ | LiTFSl | Additive | resistance | cycle | rate | increase rate | occurrence |
| Example | 0.65 | 0.35 | 0.15 | | SF | 259 | 70 | 84 | 125 | 0.13 |
| 10 | | | | | compound | | | | | |
| | | | | | 10.0 | | | | | |
| Example | 0.65 | 0.35 | 0.15 | | SF | 248 | 78 | 91 | 108 | 0.11 |
| 11 | | | | | compound | | | | | |
| | | | | | 7.0 | | | | | |
| Example | 0.65 | 0.35 | 0.15 | | SF | 241 | 79 | 91 | 107 | 0.11 |
| 12 | | | | | compound | | | | | |
| | | | | | 5.0 | | | | | |
| Example | 0.65 | 0.35 | 0.15 | | SF | 237 | 80 | 91 | 105 | 0.12 |
| 13 | | | | | compound | | | | | |
| | | | | | 3.0 | | | | | |
| Example | 0.65 | 0.35 | 0.15 | | SF | 232 | 74 | 85 | 112 | 0.15 |
| 14 | | | | | compound | | | | | |
| | | | | | 1.0 | | | | | |

Combination of other FECs, sulfone compounds, and other additives were performed, and the results are compared and shown again in Table 7.

TABLE 7

| | | | | | | | Life at | Stored at 60° C. (for 30 days) | | |
|---|---|---|---|---|---|---|---|---|---|---|
| | | | | | | | 25° C. | Capacity | | Amount of |
| Example | Lithium salt | | | | | Initial | 300^{th} | retention | Resistance | gas |
| No. | LiPF₆ | LiFSl | LiBF₄ | LiTFSl | Additive | resistance | cycle | rate | increase rate | occurrence |
| Example | 0.65 | 0.35 | 0.15 | | FEC 7.0 | 251 | 73 | 88 | 121 | 0.29 |
| 2 | | | | | | | | | | |
| Example | 0.65 | 0.35 | 0.15 | | SF compound | 248 | 78 | 91 | 108 | 0.11 |
| 11 | | | | | 7.0 | | | | | |
| Example | 0.65 | 0.35 | 0.15 | | FEC 4.0 + SF | 246 | 82 | 92 | 108 | 0.14 |
| 15 | | | | | compound 3.0 | | | | | |
| Example | 0.65 | 0.35 | 0.15 | | FEC 4.0 + PS | 250 | 81 | 92 | 102 | 0.07 |
| 16 | | | | | 1.0 + SF | | | | | |
| | | | | | compound 3.0 | | | | | |
| Example | 0.65 | 0.35 | 0.15 | | FEC | 247 | 82 | 92 | 103 | 0.09 |
| 17 | | | | | 4.0 ++ ESA | | | | | |
| | | | | | 1.0 + SF | | | | | |
| | | | | | compound 3.0 | | | | | |

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

### EXPLANATION OF REFERENCE NUMERALS DESIGNATING THE MAJOR ELEMENTS OF THE DRAWINGS

30: a lithium battery
22: an anode
23: a cathode
24: a separator
25: a battery case
26: a cap assembly

1. An electrolyte for a lithium battery, the electrolyte comprising:
a non-aqueous organic solvent; and
a lithium salt comprising lithium hexafluoro phosphate (LiPF₆), lithium bis(fluorosulfonyl) imide (LiFSI), and lithiumtetrafluoroborate (LiBF₄), wherein
based on 1 mole (mol) of LiPF₆, the amount of LiFSI is in a range of about 0.01 mol to about 1.2 mol, and the amount of LiBF₄ is in a range of about 0.05 mol to about 0.7 mol.

2. The electrolyte of claim 1, wherein
based on 1 mol of LiPF₆, the amount of LiFSI is in a range of about 0.1 mol to about 1 mol.

3. The electrolyte of claim 1, wherein
based on 1 mol of LiPF₆, the amount of LiBF₄ is in a range of about 0.08 mol to about 0.6 mol.

4. The electrolyte of claim 1, wherein
the total concentration of the lithium salt in the electrolyte is in a range of about 0.9 M to about 1.8 M.

5. The electrolyte of claim 1, further comprising
a sulfone compound represented by Formula 1 as an additive: 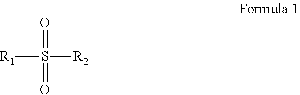
wherein, in Formula 1, at least one of R₁ and R₂ is a fluorine atom or a C1-C12 chain hydrocarbon group substituted with a fluorine atom, and the other one of R₁ and R₂ is a hydrogen atom or an unsubstituted C1-C12 chain hydrocarbon group.

6. The electrolyte of claim 5, wherein
the sulfone compound comprises methanesulfonyl fluoride, ethanesulfonyl fluoride, propanesulfonyl fluoride, 2-propanesulfonyl fluoride, butanesulfonyl fluoride, 2-butane sulfonyl fluoride, hexanesulfonyl fluoride, octanesulfonyl fluoride, decanesulfonyl fluoride, dodecanesulfonyl fluoride, cyclohexanesulfonyl fluoride, trifluoromethanesulfonyl fluoride, perfluoroethanesulfonyl fluoride, perfluoropropanesulfonyl fluoride, perfluorobutanesulfonyl fluoride, ethenesulfonyl fluoride, 1-propene-1-sulfonyl fluoride, 2-propene-1-sulfonyl fluoride, 2-methoxy-ethanesulfonyl fluoride, 2-ethoxy-ethanesulfonyl fluoride, or a combination thereof.

7. The electrolyte of claim 5, wherein
an amount of the sulfone compound is in a range of about 1% by weight (wt %) to about 10 wt % based on 100 wt % of the total weight of the lithium salt, the solvent, and the additive.

8. The electrolyte of claim 1, further comprising
as an additive a fluoro carbonate compound that is selected from fluoroethylene carbonate (FEC), 4,5-difluoroethylenecarbonate, 4,4-difluoroethylenecarbonate, 4,4,5-trifluoroethylenecarbonate, 4,4,5,5-tetrafluoroethylenecarbonate, 4-fluoro-5-methylethylenecarbonate, 4-fluoro-4-methylethylenecarbonate, 4,5-difluoro-4-methylethylenecarbonate, 4,4,5-trifluoro-5-methylethylenecarbonate, trifluoromethylethylenecarbonate, and a combination thereof.

9. The electrolyte of claim 1, further comprising
at least one additive selected from the group consisting of tris(trimethylsilyl)phosphate (TMSPa), lithium difluorooxalatoborate (LiFOB), vinylene carbonate (VC), propanesultone (PS), succinonitrile (SN), LiBF₄, a silane compound having a functional group capable of forming a siloxane bond, and a silazane compound.

10. A lithium battery comprising:
a cathode;
an anode; and
the electrolyte of claim 1 disposed between the cathode and the anode.
